(19) United States
(12) Patent Application Publication
(10) Pub. No.: US 2004/0025730 A1
(43) Pub. Date: Feb. 12, 2004

(54) Method for imaging a lithographic printing plate

(76) Inventors: Howard A. Fromson, Stonington, CT (US); William J. Rozell, Vernon, CT (US)

Correspondence Address: Alix, Yale & Ristas, 750 Main Street, Hartford, CT, 06103-2721, US

(21) Appl. No.: 10/324,918

(22) Filed: Dec. 20, 2002

Related U.S. Application Data
(63) Continuation-in-part of application No. 10/213,831, filed on Aug. 6, 2002, now abandoned.

(51) Int. Cl. B41N 3/00; B41M 5/00

(52) U.S. Cl. 101/465

(57) ABSTRACT

A lithographic printing plate has a hydrophilic substrate and an oleophilic coating. The plate is simultaneously imaged and developed by applying a solvent for the coating in an image-wise pattern using an ink jet printer. The oleophilic coating is thereby removed in those areas where the solvent has been jetted exposing the hydrophilic substrate and leaving the residual oleophilic coating in the form of the desired positive image. The residual oleophilic coating may be post treated to insolubilize and/or harden the image.

This application is a continuation-in-part of application Ser. No. 10/213,831 filed Aug. 6, 2002.

The present invention relates to a method for producing an imaged, processed lithographic printing plate in a one-step process comprising simultaneously imaging and developing the plate by delivering a solvent in an image-wise pattern by ink jet.

### BACKGROUND OF THE INVENTION

There are presently several techniques proposed to make imaged lithographic printing plates using ink jet technology. One obvious method is to apply an oleophilic material in an image-wise pattern by ink jet directly onto a hydrophilic substrate. This method suffers from several drawbacks. It is problematic to find an ink that has good properties for jetting and is substantial enough to endure as the image area on a printing plate for a satisfactory number of impressions. Also, since the hydrophilic substrates are often roughened to improve plate performance, they do not serve as good receiving surfaces for jetted inks.

Another alternative method is to ink jet a photomask onto an actinically imageable plate. The plate has a conventional light sensitive coating and may be positive working or negative working. An ink is jetted in an image-wise pattern on the plate surface. The ink is opaque at the wavelength at which coating is sensitive. The plate is blanket exposed to the imaging radiation after the ink jet writing. The light sensitive areas that are not covered by the jetted ink become exposed by the imaging radiation while the areas covered by the opaque ink remain unexposed. The plate is then subjected to development with the appropriate developing solution to remove the soluble areas of the coating.

U.S. Pat. No. 6,014,931 discloses another alternative method for using ink jet technology to image a plate. A hydrophilic substrate is coated with a first layer that is soluble in a solvent. A second coating is applied in an image-wise pattern by ink jet, with the requirement that the second coating have good adhesion to the first coating and be insoluble in the solvent for the first coating. Upon processing the plate with the solvent, the first coating layer is selectively removed in those areas which are not protected by the insoluble second layer. This method is thus positive working since the areas selectively written by the ink jet process are the areas where the coating remains after processing. The disclosure further allows for the use of actinically sensitive coatings and transparent ink jet fluids to allow for the coating to be further hardened after the processing step.

U.S. Pat. No. 6,315,916 is directed at a further alternative technique for using ink jet to image a plate. The plate used has a negative working coating containing a diazo resin. An alkaline fluid is applied in an image-wise pattern by ink jet onto the diazo resin coating. The alkaline fluid causes an insolubilizing reaction to occur in the coating in the ink jet written areas. The plate is then developed to remove the areas of coating which were not written by the ink jet and remain soluble.

### SUMMARY OF THE PRESENT INVENTION

The present invention is directed at an improved method for imaging a lithographic printing plate using ink jet. One of the objectives of the invention is to avoid the drawbacks of the method of directly ink jetting an oleophilic material onto a hydrophilic substrate as previously discussed. Another objective is to avoid the requirement of at least two discrete steps to obtain an imaged, developed plate common to other alternatives for imaging using ink jet technology. The present invention simplifies the imaging and developing of the plate by accomplishing both imaging and developing in a single process.

According to the present invention, a lithographic printing plate is simultaneously imaged and developed by applying a solvent/developer in an image wise pattern by ink jet. The printing plate of the present invention comprises a hydrophilic substrate with an oleophilic coating. The oleophilic coating need not be photosensitive, but must be soluble in a fluid which can be selectively applied by ink jet. The oleophilic coating is removed only in those areas where the solvent has been jetted, revealing the hydrophilic substrate beneath the coating in those areas. Thus, imaging and development have been accomplished in a single step.

### DETAILED DESCRIPTION OF THE INVENTION

The printing plate of the present invention comprises a hydrophilic substrate with an oleophilic coating.

The substrate may be any of the hydrophilic substrates suitable for use in printing plate construction. Preferred is an aluminum sheet that has been grained, anodized and optionally post-treated. Suitable techniques for preparing an aluminum sheet as a substrate for a lithographic printing plate are described in U.S. Pat. No. 4,183,788, Re 29,745 and U.S. Pat. No. 3,181,461. This prior art is not intended to limit the range of methods or materials suitable for use in the preparation of a lithographic substrate. Other techniques known in the art are also within the scope of the present invention.

The oleophilic coating of the present invention may be any resin or polymeric material that has the appropriate ink receptivity and the necessary mechanical properties to give the required number of printed impressions. The coating must be soluble in the fluid that is selectively applied by ink jet. An advantage of the present invention is that it does not rely on any change in solubility of the coating to effect the imaging. With traditional developers, some change must take place in the solubility of the resin in selected areas of the plate such that overall washing of the plate with developer only removes selected areas. In the present invention, the imaging takes place as a result of the selective application of the solvent. There is no selective change in solubility required. This allows for a greater range of selection of oleophilic materials for the coating. The coatings do not require dissolution inhibitors, sensitizers or crosslinking agents, thereby simplifying the composition. Examples of oleophilic coating materials include novolac and resole resins and acrylate resins. These materials are soluble in aqueous alkaline solutions. Suitable alkaline solutions include but are not limited to solutions of sodium metasilicate, sodium hydroxide and potassium hydroxide as well as alkaline solutions of phosphate salts and carbonate salts. Alternatively, organic solvents such as acetone, methyl ethyl ketone, 1 methoxy-2-propanol or benzyl alcohol may be used. Aqueous solutions of the compatible organic solvents can be used, as well as mixtures of solvents. Additionally, mixtures comprising an aqueous alkaline solution and a compatible organic solvent can be used. For example, aqueous alkaline solutions of sodium metasilicate to which some amount of benzyl alcohol has been added are useful. After the ink jet imaging, an optional post treatment step may be employed to harden the coating. For example, it is known that phenolic images (novolac and resole resins) can be hardened by heating.

In an alternative embodiment, the coatings may be selected such that they are capable of post treatment to further harden the coating. Examples of such coatings are well known for conventional negative-working lithographic plates. Typically, these are either photopolymer plates or diazo resin plates or combinations thereof. U.S. Pat. No. 3,929,489 discloses condensation copolymers which are capable of being crosslinked by exposure to actinic radiation in either the ultraviolet or visible range. The copolymers generally comprise copolyesters with first dicarboxylic acid derived repeating units containing non-aromatic ethylenic unsaturation capable of providing crosslinking sites and second aromatic decarboxylic acid derived repeating units containing disulfonamido units containing monovalent cations as amido nitrogen atom substituents. Coating compositions of the copolymers are soluble in solvents such as benzyl alcohol, cyclohexanone, dioxane, and 2-methoxyethyl acetate. As such, any of these are suitable fluids for application by ink jetting according to the method of the present invention. Once again, the organic solvents which are compatible may be employed as an aqueous solution. The copolymers are also soluble in aqueous alkaline solutions and these may optionally be used as the ink jetted solvent in the writing process. After imaging, the copolymers may be crosslinked by subsequent exposure to actinic radiation.

Alternatively, coating containing diazo resins may be imaged by the method of the present invention and subsequently exposed to UV radiation. One such suitable diazo resin is the condensation product of 3-methoxy-4 diazo-diphenylamine and paraformaldehyde. Other suitable diazo compounds are described in U.S. Pat. Nos. 3,406,159 and 3,311,605. These compositions are typically soluble in benzyl alcohol and various ketones and glycol ethers. Thus any of these solvents including aqueous solutions thereof can be applied by ink jetting according to the method of the present invention to selectively remove a diazo resin coating. After the ink jet imaging, the coating may be exposed to UV radiation to insolubilize and harden the image.

Included in the coating there may be selected additives to provide the required jetting properties. Such materials are well known in the art of ink jetting and may include surfactants and humectants to provide the integrity and shape of the droplets of solvents and to prevent drying on the jetting nozzles.

The simultaneous imaging and development of the plate is accomplished by the selective application of a solvent for the oleophilic coating by ink jet. The volume of solvent delivered must be controlled such that it is the minimum required to cause the dissolution of the coating. If too large a volume is applied, it will tend to spread and undercut the coating. It is thus critical that the ink jet droplet volume be properly adjusted and matched to the thickness of the coating on any particular plate. The advantage of ink jet for applying the solvent is that it allows for the delivery of small, controlled volumes of solvent. Further, the solvent should preferably have a contact angle on the coated surface of approximately 90°. If the contact angle is too low, the fluid will spread and the highlights will be lost.

The composition of an optimum solvent for use in the present invention is dependent on the exact coating composition that must be dissolved and removed. It should be obvious to one skilled in the art that the various solvents described herein are not limiting in the present invention, but are given merely as examples of materials known to be suitable for the general coating types described herein. Alternative classes of alkaline materials or organic solvents are equally suitable in the present invention when matched with a coating that has the required solubility in the respective alkaline material or organic solvent. Further, resins or polymers other than those specifically described herein may also be equally useful within the scope of the present invention. The solvents that are useful for these other resins or polymers may or may not be similar to those described herein.

The process of the present invention lends itself to imaging on press, since it does not require a distinct developing station. The minimal by-products of the one-step imaging and development process are simply rinsed away with water on press and carried away within the fountain solution.

1. A method of forming a desired positive image on a lithographic printing plate comprising a hydrophilic substrate with an oleophilic coating thereon wherein said coating is soluble in a selected solvent, said method comprising the application in a desired pattern of said selected solvent to said coating by ink jet thereby dissolving away said coating in said desired pattern and thus exposing said hydrophilic substrate and forming a residual oleophilic coating in the form of the desired positive image on the hydrophilic substrate.

2. A method as recited in claim 1 and further including the step of hardening said residual oleophilic coating.

3. A method as recited in claim 1 wherein said coating is selected from the group consisting of novalac resins, resole resins, acrylate resins, diazo resins and photopolymers.

4. A method as recited in claim 1 wherein said coating has a composition which may be insolubilized by actinic radiation and further including the step of post treating with actinic radiation to insolubilize said residual oleophilic coating.

5. A method as recited in claim 4 wherein said coating comprises a photopolymer or a diazo resin or mixtures thereof.

6. A method as recited in claim 1 wherein said coating has a composition which may be hardened by heating and further including the step of post treating by heating to harden said residual oleophilic coating.

7. A method as recited in claim 6 wherein said coating comprises a phenolic resin.

8. A method as recited in claim 1 wherein said solvent is an aqueous solution.

9. A method as recited in claim 8 wherein said aqueous solution is a solution of sodium metasilicate.

10. A method as recited in claim 8 wherein said aqueous solution is an aqueous alkaline solution.

11. A method as recited in claim 1 wherein said solvent comprises an organic solvent.

12. A method as recited in claim 8 wherein said aqueous solution contains an organic solvent.

13. A method as recited in claim 12 wherein said aqueous solution is an aqueous alkaline solution.

14. A method as recited in claim 13 wherein said aqueous solution comprises a solution of sodium metasilicate and said organic solvent is benzyl alcohol.

15. A method as recited in claim 11 wherein said organic solvent is selected from the group consisting of ketones, alcohols, ethers and ether linked alcohols and acetates.

16. A method as recited in claim 15 wherein said solvent is selected from the group consisting of methyl ethyl ketone, cyclohexanone, acetone, glycol ethers, dioxane, benzyl alcohol, 1-methoxy-2-propanol and 3-methoxyethyl acetate.
